(19) United States
(12) Patent Application Publication
(10) Pub. No.: US 2021/0012398 A1
(43) Pub. Date: Jan. 14, 2021

(54) METHOD FOR CONTROLLING POWER OF ELECTRONIC DEVICE AND SERVER THEREFOR

(71) Applicant: Samsung Electronics Co., Ltd., Suwon-si, Gyeonggi-do (KR)

(72) Inventors: Youngjoo LEE, Suwon-si (KR); Byungsoo KIM, Suwon-si (KR); Seungyeon EOM, Suwon-si (KR); Dooman LEE, Suwon-si (KR)

(21) Appl. No.: 17/041,218

(22) PCT Filed: Apr. 1, 2019
(86) PCT No.: PCT/KR2019/003790

§ 371 Date: Sep. 24, 2020

(30) Foreign Application Priority Data
Apr. 4, 2018 (KR) 10-2018-0039130

(51) Int. Cl. G06Q 30/02; G06Q 10/06; H02J 3/00

(52) U.S. Cl. CPC G06Q 30/0283; G06Q 30/0226; G06Q 50/06; H02J 3/003; G06Q 10/06315

(57) ABSTRACT

Disclosed is a server comprising: at least one processor; a communication circuit electrically connected to the at least one processor and transmitting or receiving a signal to/from an external device; and a memory electrically connected to the at least one processor and storing group information and control information, the group information representing at least one group including a group comprising a first electronic device and a second electronic device, and the control information being associated with each of the at least one group, wherein the at least one processor is configured so as to acquire demand response (DR)-associated information, and as a response to the DR-associated information, transmit the control information associated with the group to the first electronic device and the second electronic device. In addition, various embodiments are possible as identified in the specification.

### TECHNICAL FIELD

Embodiments disclosed in the disclosure relate to a demand response (DR).

### BACKGROUND ART

A demand response (DR) is a technology of controlling power depending on variation in the entire demand of a load for the reliability and optimization of infrastructures. For example, as a fee in peak hours when the load is concentrated is set to a high price in an advanced metering infrastructure (AMI) system or the like, the DR may operate in the direction of reducing the use of energy.

The DR may mean that a consumer uses power in response to a price, a monetary reward, or the instruction of an electric power company. The electric power company guides a consumer to reduce power consumption for stable power supply to provide a monetary reward.

### DISCLOSURE

### Technical Problem

According to the related art, while a DR is applied, an electronic device operates using a predefined DR program. When applying the predefined DR program irrespective of characteristics of the electronic device, because the electronic device frequently operates in such a manner as to degrade a correlation with a usage pattern of a user, the satisfaction of the user may be degraded. In this case, as there may be an increase in the ratio where the user selects to override the DR, the effect of the DR program may be reduced.

Various embodiments disclosed in the disclosure are to provide a method for controlling an operation of an electronic device based on a usage pattern of a user (or an operation pattern of the electronic device) and a server therefor.

### Technical Solution

In accordance with an aspect of the disclosure, a server is provided. The server may include at least one processor, a communication circuit configured to be electrically connected with the at least one processor and transmit or receive a signal with an external device, and a memory, electrically connected with the at least one processor, for storing group information indicating at least one group including a group including a first electronic device and a second electronic device and control information associated with the at least one group. The at least one processor may be configured to obtain information associated with a demand response (DR) and transmit the control information associated with the group to the first electronic device and the second electronic device, in response to the information associated with the DR.

In accordance with another aspect of the disclosure, a method is provided. The method may include obtaining information associated with a demand response (DR), transmitting control information associated with a group including a first electronic device to the first electronic device, in response to the information associated with the DR, and transmitting the control information to a second electronic device included in the group.

### Advantageous Effects

According to embodiments disclosed in the disclosure, DR application efficiency may be increased and power may be efficiently saved.

According to embodiments disclosed in the disclosure, the satisfaction of the user with the use of the electronic device may be increased while applying the DR.

In addition, various effects ascertained directly or indirectly through the disclosure may be provided.

### DESCRIPTION OF DRAWINGS

FIG. 1 illustrates a network environment to which a demand response (DR) is applied according to an embodiment;

FIG. 2 is a configuration block diagram of a server according to an embodiment;

FIG. 3 illustrates a configuration of a server according to an embodiment;

FIG. 4 is a flowchart of an operation of controlling a plurality of electronic devices in a server according to an embodiment;

FIG. 5 is a flowchart of an operation of generating control information based on information associated with an operation in a server according to an embodiment;

FIG. 6 is an operational flowchart for updating group information or control information based on feedback information in a server according to an embodiment;

FIG. 7 illustrates operation flow of a server according to an embodiment;

FIG. 8 is electronic device grouping of a server according to an embodiment;

FIG. 9 illustrates information associated with an operation, which is obtained by a server, according to an embodiment;

FIG. 10 illustrates information collected in a database of a server according to an embodiment; and

FIG. 11 is a block diagram illustrating an electronic device in a network environment according to various embodiments.

### MODE FOR INVENTION

Hereinafter, various embodiments of the disclosure may be described with reference to accompanying drawings. However, it should be understood that this is not intended to limit the disclosure to specific implementation forms and includes various modifications, equivalents, and/or alternatives of embodiments of the disclosure. With regard to description of drawings, the same or similar denotations may be used for the same or similar components.

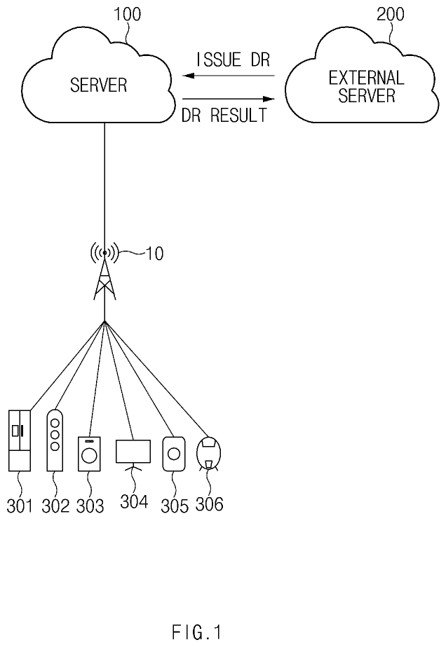

FIG. 1 illustrates a network environment to which a demand response (DR) is applied according to an embodiment.

According to an embodiment, the DR may operate in a network environment including a server 100, an external server 200, and at least one electronic device 301, 302, 303, 304, 305, and 306.

According to an embodiment, when the external server 200 issues the DR, the server 100 may apply a DR program to the plurality of electronic devices 301, 302, 303, 304, 305, and 306 in response to issuing the DR. To this end, the server 100 may transmit control information associated with power to the plurality of electronic devices 301, 302, 303, 304, 305, and 306. The server 100 may transmit a DR result to the external server 200 and may receive a reward from the external server 200 when there is power saving.

According to an embodiment, the server 100 may be a server which controls operations of the plurality of electronic devices 301, 302, 303, 304, 305, and 306. For example, the server 100 may control operations of the plurality of electronic devices 301, 302, 303, 304, 305, and 306 with regard to the amount of power supplied from the external server 200. In addition, the server 100 may perform various operations associated with the plurality of electronic devices 301, 302, 303, 304, 305, and 306.

According to an embodiment, the server 100 may control operations of the electronic devices 301, 302, 303, 304, 305, and 306 to reduce the amount of power consumed by the plurality of electronic devices 301, 302, 303, 304, 305, and 306. To this end, the server 100 may store the DR program, such that the electronic devices 301, 302, 303, 304, 305, and 306 execute an operation according to the DR program. According to an embodiment, the server 100 may be a smart appliance server.

According to an embodiment, the external server 200 may be a DR server which issues the DR. The external server 200 may issue the DR and may obtain the DR result from the server 100. Based on the DR result obtained from the server 100, the external server 200 may provide the server 100 with a reward. The external server 200 may transmit information associated with the DR to the electronic device, such that the electronic device 301, 302, 303, 304, 305, or 306 apply the DR. The information associated with the DR may be in the form of a DR request and a DR command. The external server 200 may be, for example, a power supplier server.

According to an embodiment, the plurality of electronic devices 301, 302, 303, 304, 305, and 306 may run a program associated with the DR under control of the server 100. The plurality of electronic devices 301, 302, 303, 304, 305, and 306 may obtain control information associated with an operation to perform a specific operation from the server 100 and may operate based on the control information. The control information may include program information associated with the DR.

According to an embodiment, the plurality of electronic devices 301, 302, 303, 304, 305, and 306 may have an operation pattern. The operation pattern may correspond to a usage pattern of a user. The plurality of electronic devices 301, 302, 303, 304, 305, and 306 may provide the server 100 with information associated with the performed operation. The plurality of electronic devices 301, 302, 303, 304, 305, and 306 may provide the server 100 with information associated with an operation performed while the DR is applied.

According to an embodiment, the plurality of electronic devices 301, 302, 303, 304, 305, and 306 may be smart home appliances. For example, the electronic devices 301, 302, 303, 304, 305, and 306 may be devices such as refrigerators, air conditioners, televisions (TVs), or laptops.

According to an embodiment, the plurality of electronic devices 301, 302, 303, 304, 305, and 306 and the server 100 may transmit or receive information over a network 10. According to an embodiment, the network 10 may include a wired network or a wireless network.

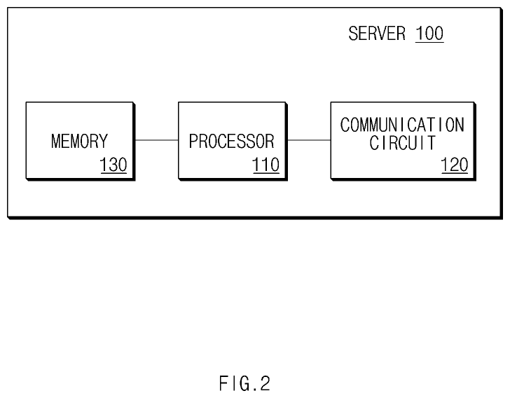

FIG. 2 is a configuration block diagram of a server according to an embodiment.

Referring to FIG. 2, a server 100 (e.g., a server 100 of FIG. 1) may include a processor 110, a communication circuit 120, and a memory 130. The configuration of the server 100 shown in FIG. 1 is illustrative, and may facilitate various modifications capable of implementing various embodiments disclosed in the disclosure.

According to an embodiment, the processor 110 may execute various operations disclosed in the disclosure or may execute instructions stored in the memory 130, and may perform an operation according to various embodiments disclosed in the disclosure or may control other components to perform the operation. For example, the processor 110 may obtain information associated with an operation, which is obtained from a plurality of electronic devices (e.g., electronic devices 301, 302, 303, 304, 305, and 306 of FIG. 1), and may group the plurality of electronic devices based on the information associated with the operation. The processor 110 may generate control information associated with a group including at least one of the plurality of electronic devices based on the information associated with the operation. The processor 110 may store information in the memory 130 or may read information stored in the memory 130 for various operations disclosed in the disclosure. The processor 110 may perform communication with an external device via the communication circuit 120. According to an embodiment, the processor 110 may include an application processor and/or a communication processor.

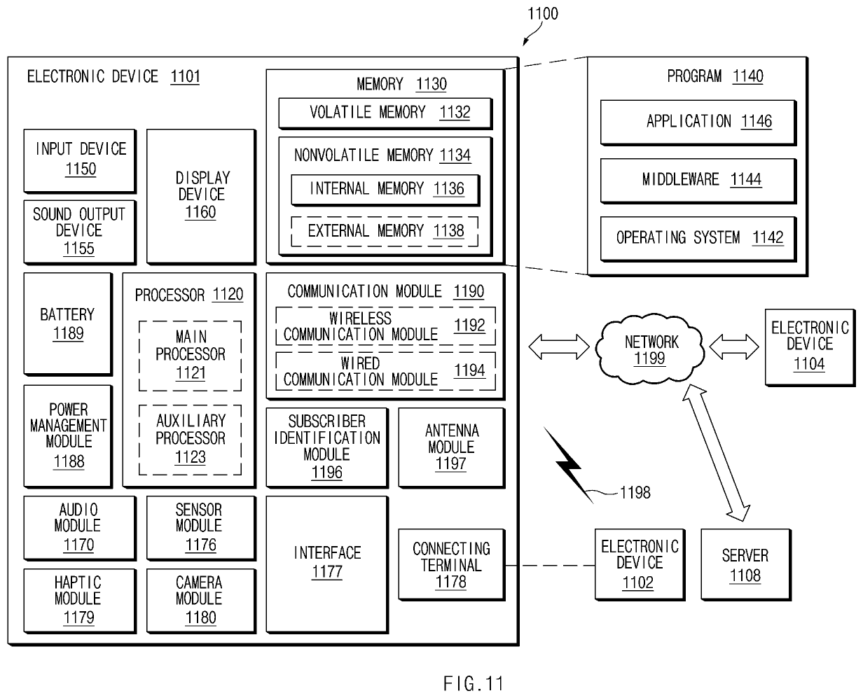

According to an embodiment, the communication circuit 120 may communicate with the external device over a network (e.g., a network 10 of FIG. 1). For example, the communication circuit 120 may perform communication with the network 10 using wired communication or wireless communication. According to an embodiment, the communication circuit 120 may be included in a communication module 1190 of FIG. 11.

According to an embodiment, the memory 130 (e.g., a memory 1130 of FIG. 11) may store information according to various embodiments disclosed in the disclosure. For example, the memory 130 may store information associated with the operation, group information, or control information. The memory 130 according to an embodiment may store instructions causing the processor 110 to perform an operation according to an embodiment disclosed in the disclosure.

According to an embodiment, the group information may indicate a group including at least one electronic device. The group information may include, for example, a correlation between the electronic device and the group.

According to an embodiment, the control information may be associated with the group information. For example, specific control information may be control information associated with a specific group.

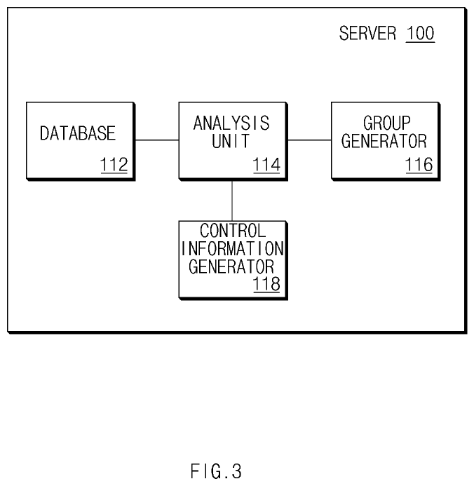

FIG. 3 illustrates a configuration of a server according to an embodiment.

A server 100 of FIG. 3 (e.g., a server 100 of FIG. 1 or 2) may include a module for performing operations according to various embodiments disclosed in the disclosure. The module may be implemented with software or hardware. According to an embodiment, a database 112 may be implemented by a memory 130 of FIG. 2, and an analysis unit 114, a group generator 116, or a control information generator 118 may be implemented by a processor 110 of FIG. 2.

According to an embodiment, the server 100 may include at least one of the database 112, the analysis unit 114, the group generator 116, and the control information generator 118.

According to an embodiment, the database 112 may be a storage device or a software module, which is capable of storing a variety of information disclosed in the disclosure. Information associated with an operation, which is obtained from a plurality of electronic devices, may be stored in the database 112. The information associated with the operation may include log information where an operation of the electronic device is recorded over time. According to an embodiment, the information associated with the operation may include at least one of operation information of the electronic device, time information where a specific operation is performed, electronic device information (e.g., an identification of the electronic device, a type of the electronic device, or owner information of the electronic device), network information (e.g., a network identification), information associated with a DR (e.g., whether to apply the DR, a DR application time, whether to override the DR, or the like). Group information indicating electronic devices grouped according to an operation pattern or an operation characteristic may be stored in the database 112. Control information generated for each group may be stored in the database 112.

According to an embodiment, the analysis unit 114 may analyze an operation pattern of the electronic devices based on the information associated with the operation, which is obtained from the plurality of electronic devices. The analysis unit 114 may obtain the information associated with the operation from the database 112. The information associated with the operation may be log information of the electronic devices.

According to an embodiment, the analysis unit 114 may analyze an operation pattern based on the information associated with the operation.

According to an embodiment, the group generator 116 may group electronic devices having a similar operation pattern. According to an embodiment, the group generator 116 may classify operation patterns into operation characteristics and may group electronic devices having the same operation characteristic into one group. Hereinafter, for convenience of description, the electronic device having the same operation characteristic may be represented as the electronic device having the same operation pattern. Through the grouping, a group including at least one electronic device may be generated for each operation pattern. The generated groups may be separated from each other by an operation pattern. The group generator 116 may generate group information indicating each group. The group information may include a correlation between the electronic device and the group.

According to an embodiment, each group may include at least one electronic device. The groups may include different electronic devices, respectively, but may include the same electronic device depending on an operation pattern. In other words, one electronic device may be included in several groups. This may mean that one electronic device may have various operation patterns.

According to an embodiment, the control information generator 118 may generate control information for each group. In other words, the control information may be associated with a group. The control information generator 118 may generate control information, causing the electronic device to operate in a similar manner to an original operation pattern, for each group. The control information may be generated based on information associated with operations of electronic devices included in the related group. The control information may be associated with an operation pattern of the electronic devices included in the related group. The generated control information may be stored in the database 112. The generated control information may be stored in the database 112 in conjunction with group information.

According to an embodiment, the group generator 116 or the control information generator 118 may periodically or aperiodically change or update group information or control information. The update may include generating group information and/or control information for a new operation pattern.

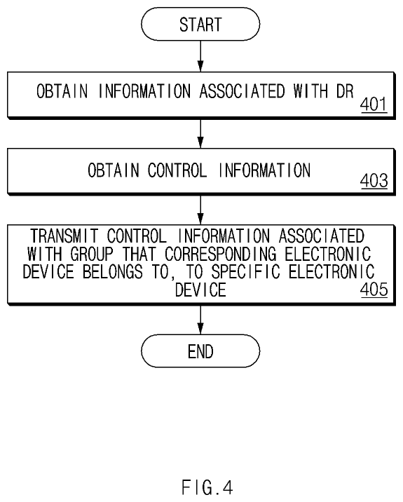

FIG. 4 is a flowchart of an operation of controlling a plurality of electronic devices in a server according to an embodiment.

Referring to FIG. 4, when a DR is issued, a server (e.g., a server 100 of FIG. 1 or 2) may transmit control information previously generated for each group to an electronic device in a group. An operation below may be executed by a processor (e.g., a processor 110 of FIG. 2), or may be stored in a memory (e.g., a memory 130 of FIG. 2) in the form of instructions to be executed by the processor.

In operation 401, the server may obtain information associated with the DR. The information associated with the DR may be DR issue. For example, the information associated with the DR may be a request or command indicating the DR.

In operation 403, the server may obtain control information. The server may obtain control information associated with a specific group. The server may obtain control information associated with a group to which a specific electronic device, which is a target to transmit control information, belongs.

In operation 405, the server may transmit, to the specific electronic device, the control information associated with the group to which a corresponding electronic device belongs . The server may transmit the same control information to an electronic device different from the specific electronic device among electronic devices included in the group. While transmitting the control information to the specific electronic device, the server may transmit the control information to at least one of electronic devices which are included in the group and are different from the specific electronic device.

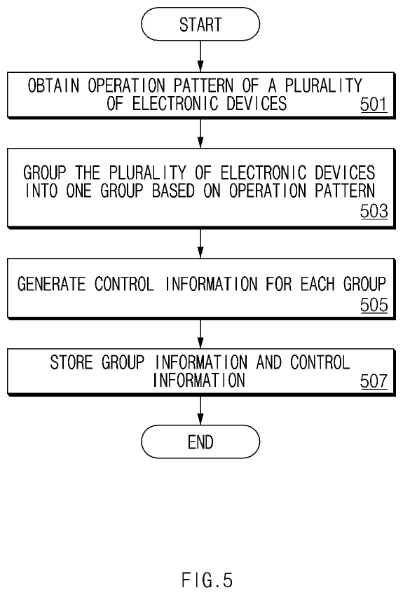

FIG. 5 is a flowchart of an operation of generating control information based on information associated with an operation in a server according to an embodiment.

Referring to FIG. 5, a server (e.g., a server 100 of FIG. 1 or 2) may obtain information associated with an operation, may group electronic devices based on the information associated with the operation, and may generate control information associated with the group. When performing the grouping, the server may analyze the information associated with the operation, may classify an operation pattern, and may group electronic devices based on the operation pattern. An operation below may be executed by a processor (e.g., a processor 110 of FIG. 2), or may be stored in a memory (e.g., a memory 130 of FIG. 2) in the form of instructions to be executed by the processor.

In operation 501, the server may obtain an operation pattern of a plurality of electronic devices. The server may obtain information associated with an operation from the plurality of electronic devices and may obtain an operation pattern of the plurality of electronic devices based on the information associated with the operation. The information associated with the operation may be stored in the server in the form of log information.

In operation 503, the server may group the plurality of electronic devices into at least one group based on the operation pattern. The server may generate a group including at least one electronic device, the operation pattern of which is the same or similar. The group may be generated for each operation characteristic (or each operation pattern).

In operation 505, the server may generate control information for each group. According to an embodiment, one group may be associated with one piece of control information, and one group may correspond to one operation characteristic (or operation pattern). In other words, generating the control information for each group may correspond to generating control information for each operation characteristic. The control information may be associated with an operation characteristic. The control information may be generated based on information associated with an operation, which is obtained from electronic devices included in the group. The control information may include, for example, program information associated with a DR causing an electronic device to perform the same or similar operation to a usual usage pattern of a user. The program associated with the DR may be a set of information indicating an operation performed while the electronic device applies the DR.

In operation 507, the server may store at least one of the generated group information or the control information. The server may store the information in a database (e.g., a database 112 of FIG. 3).

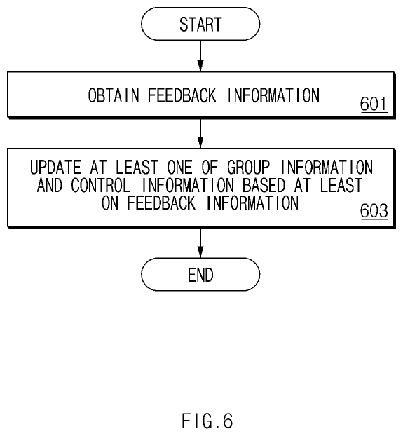

FIG. 6 is an operational flowchart for updating group information or control information based on feedback information in a server according to an embodiment.

Referring to FIG. 6, a server (e.g., a server 100 of FIG. 1 or 2) may obtain information associated with an operation performed by an electronic device while applying a DR as feedback information. Based on the feedback information, the server may update group information or control information and may more accurately reflect a usage pattern of a user. An operation below may be executed by a processor (e.g., a processor 110 of FIG. 2), or may be stored in a memory (e.g., a memory 130 of FIG. 2) in the form of instructions to be executed by the processor.

In operation 601, the server may obtain feedback information. The server may obtain feedback information from the electronic device. The server may obtain information associated with an operation performed by a corresponding electronic device while the server applies the DR from, for example, the electronic device which is a receiver of control information of FIG. 4.

In operation 603, the server may update at least one of group information and control information based at least on the feedback information. The server may change group information and/or control information, based on information associated with an operation included in the feedback information. The server may change a group including a specific electronic device or may change control information associated with a specific group. The server may generate a new group and may generate control information associated with the corresponding group.

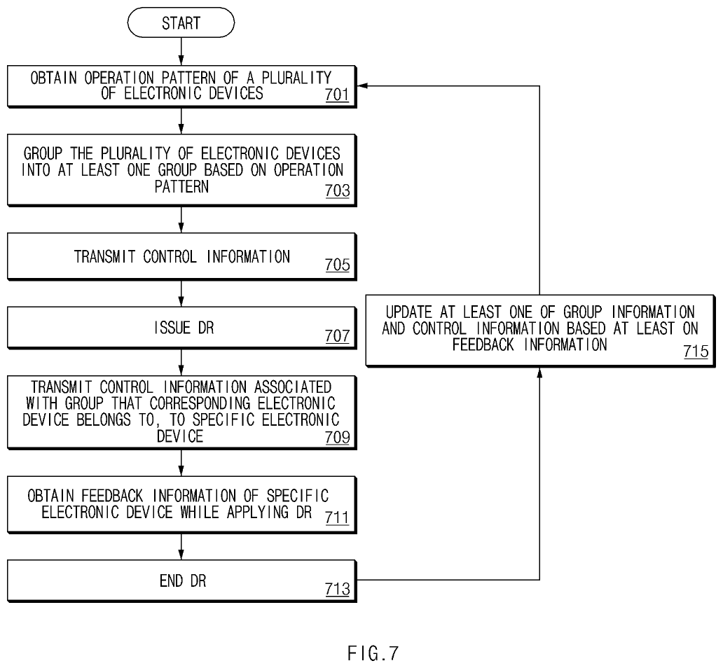

FIG. 7 illustrates operation flow of a server according to an embodiment.

An operation below may be executed by a processor (e.g., a processor 110 of FIG. 2), or may be stored in a memory (e.g., a memory 130 of FIG. 2) in the form of instructions to be executed by the processor.

In operation 701 the server may obtain an operation pattern of a plurality of electronic devices. Operation 701 may be the same as or similar to operation 501 of FIG. 5. The server may obtain the operation pattern based on information associated with an operation, which is obtained from an electronic device.

In operation 703 the server may group the plurality of electronic devices into at least one group based on the operation pattern. Operation 703 may be the same as or similar to operation 503 of FIG. 5. The server may group at least one electronic device having a similar operation pattern into one group.

In operation 705, the server may generate control information. Operation 705 may be the same as or similar to operation 505 of FIG. 5. The server may generate control information causing an electronic device in each group to operate in the same or similar manner to a usage pattern of a user. The control information may be associated with a group. According to an embodiment, the control information may be associated with an operation. For example, the server may generate, for the specific group, control information associated with an operation characteristic (or an operation or an operation pattern) of a corresponding group. The server may generate control information based on information associated with the operation.

In operation 707, the server may obtain DR issue. The server may be issued with a DR from an external server (e.g., an external server 200 of FIG. 1). Operation 707 may be the same as or similar to operation 401 of FIG. 4.

In operation 709, the server may transmit, to the specific electronic device, control information associated with a group to which a corresponding electronic device belongs. The server may control the specific electronic device using the control information associated with the group to which the specific electronic device belongs.

The server may transmit the same control information to another electronic device in the corresponding group. For example, it may be assumed that a first electronic device and a second electronic device belong to a first group and that a third electronic device belongs to a second group. The server may transmit first control information associated with the first group to the first electronic device and may transmit the first control information to the second electronic device. The server may transmit second control information associated with the second group to the third electronic device. When the first electronic device belongs to a third group having another operation characteristic, the server may transmit third control information associated with third group to the first electronic device.

In operation 711, the server may obtain feedback information of the specific electronic device while applying the DR. Operation 711 may be the same as or similar to operation 601 of FIG. 6. The server may receive feedback information from the specific electronic device while applying the DR. The feedback information may include information associated with an operation of the electronic device, which is performed while the server applies the DR.

In operation 713, the server may end the DR. The server may end the DR and may transmit the DR result to the external server.

In operation 715, the server may update at least one of group information and control information based on the feedback information. Operation 715 may be the same as or similar to operation 603 of FIG. 6. The server may end the DR and may change group information and/or control information based on the feedback information, in response to ending the DR.

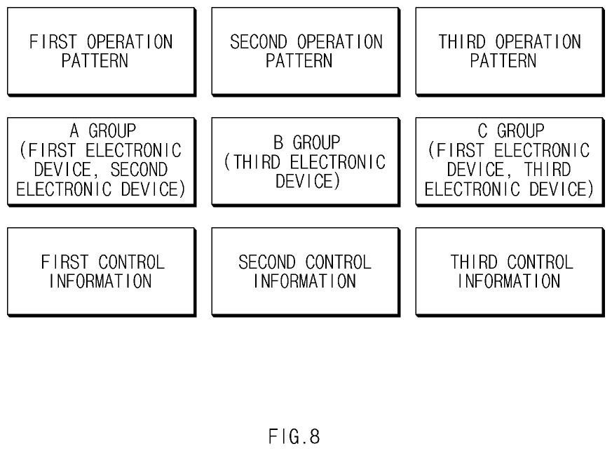

FIG. 8 is electronic device grouping of a server according to an embodiment.

Referring to FIG. 8, the server may group a plurality of electronic devices depending on an operation pattern and may generate control information suitable for each group. According to an embodiment, the server may include at least one electronic device having a similar operation pattern in one group for each operation pattern. FIG. 8 illustrates one example of grouping electronic devices in a server, and does not limit the scope of the disclosure.

According to an embodiment, the server may analyze operation information of the plurality of electronic devices and may classify operation patterns into a first operation pattern, a second operation pattern, and a third operation pattern based on the operation information.

The server may group electronic devices having the first operation pattern into A group, may group electronic devices having the second operation pattern into B group, and may group electronic devices having the third operation pattern into C group. Having a specific operation pattern may mean that the electronic device has similar operation flow for any characteristic. Alternatively, it may be meant that a user uses the electronic device in a similar usage pattern for any characteristic.

In FIG. 8, it is exemplified that the server includes a first electronic device (e.g., an electronic device 301 of FIG. 1) and a second electronic device (e.g., an electronic device 302 of FIG. 1) in A group, includes a third electronic device (e.g., an electronic device 303 of FIG. 1) in B group, and includes the first electronic device and the third electronic device in C group.

According to an embodiment, the electronic device may be included in duplicate in different groups. For example, the first electronic device may be included in C group as well as A group.

According to an embodiment, the server may generate control information for each group (or for each operation pattern). The server may generate first control information for the first operation pattern or A group, may generate second control information for the second operation pattern or B group, and may generate third control information for the third operation information or C group.

According to an embodiment, an operation pattern or a group may be associated with the control information. The control information may be generated based on information associated with an operation pattern or an operation. For example, the server may generate the first control information such that the electronic device included in A group may perform an operation suitable for the first operation pattern.

The server may generate the second control information such that the electronic device included in B group may perform an operation suitable for the second operation pattern. The server may generate the third control information such that the electronic device included in C group may perform an operation suitable for the third operation pattern.

When a DR is issued, the server may transmit control information associated with a group including a specific electronic device to the electronic device. For example, when controlling the first electronic device, the server may transmit the first control information to the first electronic device. In this case, the server may transmit the first control information which is the same control information to the second electronic device.

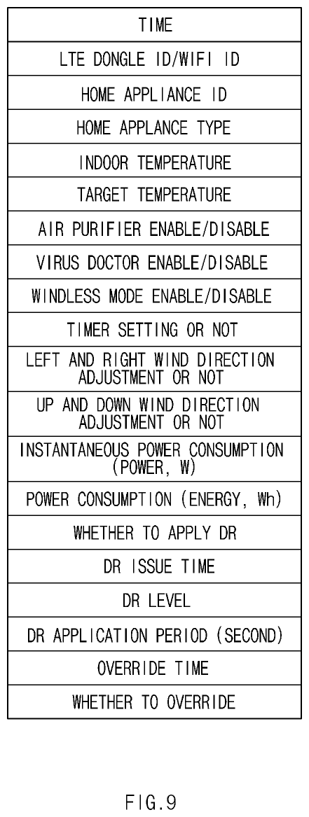

FIG. 9 illustrates information associated with an operation, which is obtained by a server, according to an embodiment.

FIG. 9 illustrates information associated with an operation, which is obtained by a server (e.g., a server 100 of FIG. 1), from a corresponding electronic device, when the electronic device is an air conditioner.

Referring to FIG. 9, the server may obtain information associated with an operation from the electronic device. The information associated with the operation may include at least one of operation information of the electronic device, electronic device information (e.g., a home appliance identification (ID) or a home appliance type), information associated with power (e.g., instantaneous power consumption, the amount of power consumption, or the like), a network ID (e.g., long term evolution (LTE) dongle ID or a wireless fidelity (Wi-Fi) ID), and information associated with a DR.

According to an embodiment, the information associated with the operation may include an operation item capable of being extracted from a log of the electronic device and time information associated with operation on/off of the electronic device. For example, the information associated with the operation may include information indicating an indoor temperature, a target temperature, air purifier enable/disable, windless mode enable/disable, timer setting or not, left and right wind direction adjustment or not, or up and down wind direction adjustment or not.

According to an embodiment, the information associated with the DR may include at least one of operation information associated with the DR or on/off time information associated with the DR. For example, the information associated with the DR may include information indicating whether to apply DR, a DR issue time, a DR level, a DR application period, a DR override time, or DR override or not.

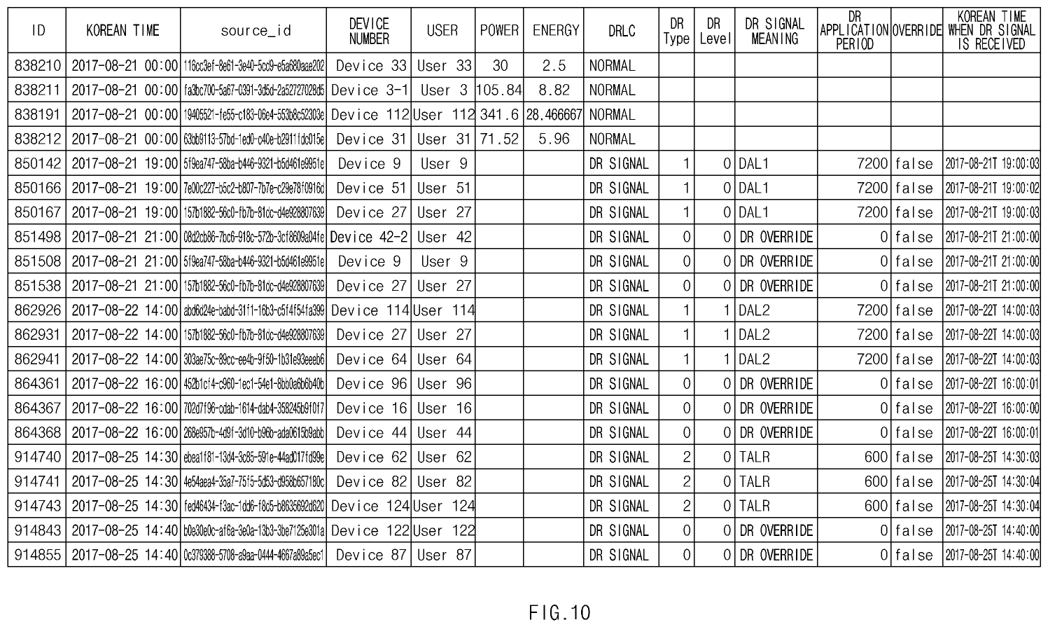

FIG. 10 illustrates information collected in a database of a server according to an embodiment.

Referring to FIG. 10, a server (e.g., a server 100 of FIG. 3) may store information collected from an electronic device or information generated based on the corresponding information in a database.

According to an embodiment, an identification (ID) of operation information, time information (e.g., Korean time), electronic device information (e.g., an electronic device ID (source_id), a device number, or a device type), user information (e.g., a user ID), information (power, energy) associated with power, or information associated with a DR (DR application enable/disable (DRLC or not), a DR type, a DR level, a DR signal meaning, a DR application period, override information, a time when a DR signal is obtained, or the like) may be stored in the database. The information may be stored in the database for each operation information. The operation information may be stored in the database over time.

Hereinafter, an example of a group classification operation of a server will be described with reference to when the electronic device includes an air conditioner.

The electronic device may classify the following group depending on an operation pattern.

A. A group where a current reference air-conditioning function is turned on

B. A group having a high probability that the air-conditioning function will be turned on during a DR issue period (e.g., a group having a high probability that the air-conditioning will be turned on between 2 and 4 this afternoon)

C. A group where a difference in current indoor temperature or a difference in target temperature is greater than or equal to X degrees

D. A group having a high probability that a difference between an indoor temperature and a target temperature will be greater than or equal to X degrees (based on previous data) during a DR issue period (based on the previous data)

E. A group having a high probability that a target temperature will be reduced after an indoor temperature arrives at the target temperature during a DR issue period (based on previous data)

F. A group having a high probability that a target temperature will be increased after an indoor temperature arrives at the target temperature during a DR issue period (based on previous data)

G. A group having a high probability that DR override will be performed during a DR issue period (based on previous data)

H. A group based on current mood power consumption (e.g., a group which currently uses an air condition over 800 W)

I. A group where the amount of power consumption is greater than or equal to a specific value during a DR issue period (based on previous data) (e.g., a group having high probability that the amount of power will be consumed over 300 W between 20 and 21 today)

J. A group where an action of reducing a target temperature is less than an average value during a DR issue period (based on previous data)

K. A group where the number of times and a time of running a windless mode are high (based on previous data)

L. Specify a group for each time taken until override as compared with a DR signal start time (based on previous data)

According to an embodiment, the server may classify a probability of performing a specific operation for each electronic device. Table 1 is a table indicating electronic devices in a group, such as group B, group D, or group G, indicating probability and a probability of the corresponding electronic device.

TABLE 1

| Device name | Probability |
|---|---|
| Device 1 | 99% |
| Device 2 | 98% |
| Device 3 | 85% |
| . . . | . . . |

Hereinafter, control information to be applied to the groups is exemplified.

a. control information applicable to E group—additionally apply a DR application time after an indoor temperature arrives at a target temperature, because there is room to additionally apply a DR because the indoor temperature arrives at the target temperature and the target temperature decreases again.

b. control information applicable to G group—mainly apply a weak stage among energy saving stages 1, 2, and 3 (the amount 1 of energy saving for each stage: 30%, 50%, or 70%) when applying a DR to a group having a high probability that DR override will be performed 30%, 50%, 70%)

c. control information applicable to J group—be high in the frequency of DR and be high in DR strength

d. control information applicable to K group—the home which frequently uses a windless mode reduces the number of times of DR issue or mainly applies a weak stage, because it is possible for the windless mode to perform power saving of about 90% compared with a normal mode

e. control information applicable to a group including characteristics of G, I, and L groups in common (e.g., a group having a low probability of performing DR override and taken over 10 minutes until DR override, among groups, which are currently turned on, where power consumption is greater than or equal to 800 W)—issue a DR signal in the strongest stage. Herein, TALR is mainly issued during about 10 minutes.

As mentioned above, the server may set a group of electronic devices depending on an operation pattern and may previously generate and store control information applied for each group. The control information applied for each group may be associated with an operation pattern of the electronic devices in the group.

According to an embodiment, a server may include at least one processor, a communication circuit, electrically connected with the at least one processor, for transmitting or receiving a signal with an external device, and a memory, electrically connected with the at least one processor, for storing group information indicating at least one group including a group including a first electronic device and a second electronic device and control information associated with the at least one group. The at least one processor may be configured to obtain information associated with a demand response (DR) and transmit the control information associated with the group to the first electronic device and the second electronic device, in response to the information associated with the DR.

According to an embodiment, the at least one group may include another group including a third electronic device, and the at least one processor may be configured to transmit control information associated with the another group to the third electronic device, in response to the information associated with the DR.

According to an embodiment, the at least one group may include another group including the first electronic device, and the at least one processor may be configured to transmit control information associated with the another group to the first electronic device, in response to the information associated with the DR.

According to an embodiment, the at least one processor may be configured to obtain information associated an operation from the first electronic device and the second electronic device and group the first electronic device and the second electronic device into the group based on the information associated with the operation.

According to an embodiment, the at least one processor may be configured to obtain information associated an operation from the first electronic device and the second electronic device and generate the control information associated with the group based on the information associated with the operation.

According to an embodiment, the at least one processor may be configured to obtain an operation pattern of the first electronic device and the second electronic device based on the information associated with the operation and group the first electronic device and the second electronic device based on the operation pattern.

According to an embodiment, the at least one processor may be configured to obtain information associated with an operation performed while applying the DR from the first electronic device.

According to an embodiment, the at least one processor may be configured to change the group information.

According to an embodiment, the at least one processor may be configured to change the control information associated with the group, based on the information associated with the operation.

According to an embodiment, the at least one processor may be configured to change the group information, in response to ending the DR.

According to an embodiment, the information associated with the DR may be transmitted from a DR server.

According to an embodiment, the at least one processor may be configured to transmit a DR result according to the information associated with the DR to the DR server.

According to an embodiment, the information associated with the operation may be log information.

According to an embodiment, the control information may include program information associated with the DR.

According to an embodiment, a method performed in a server may include obtaining information associated with a demand response (DR), transmitting control information associated with a group including a first electronic device to the first electronic device, in response to the information associated with the DR, and transmitting the control information to a second electronic device included in the group.

According to an embodiment, the method may further include transmitting control information associated with a group, including a third electronic device, which is different from the group to the third electronic device, in response to the information associated with the DR.

According to an embodiment, the method may further include transmitting control information associated with a group, including the first electronic device, which is different from the group to the first electronic device, in response to the information associated with the DR.

According to an embodiment, the method may further include obtaining information associated with an operation from each of the first electronic device and the second electronic device and grouping the first electronic device and the second electronic device into the group based on the information associated with the operation.

According to an embodiment, the method may further include generating the control information associated with the group based on the information associated with the operation.

According to an embodiment, the control information may include program information associated with the DR.

FIG. 11 is a block diagram illustrating an electronic device 1101 in a network environment 1100 according to various embodiments.

Referring to FIG. 11, the electronic device 1101 (e.g., a plurality of electronic devices 301, 302, 303, 304, 305, and 306 of FIG. 1) in the network environment 1100 may communicate with an electronic device 1102 via a first network 1198 (e.g., a short-range wireless communication network), or an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120 (e.g., the plurality of electronic devices 301, 302, 303, 304, 305, and 306 of FIG. 1), memory 1130, an input device 1150, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) 1196, or an antenna module 1197. In some embodiments, at least one (e.g., the display device 1160 or the camera module 1180) of the components may be omitted from the electronic device 1101, or one or more other components may be added in the electronic device 1101. In some embodiments, some of the components may be implemented as single integrated circuit. For example, the sensor module 1176 (e.g., a fingerprint sensor, an iris sensor, or an illuminance sensor) may be implemented as embedded in the display device 1160 (e.g., a display).

The processor 1120 may execute, for example, software (e.g., a program 1140) to control at least one other component (e.g., a hardware or software component) of the electronic device 1101 coupled with the processor 1120, and may perform various data processing or computation. According to one embodiment, as at least part of the data processing or computation, the processor 1120 may load a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), and an auxiliary processor 1123 (e.g., a graphics processing unit (GPU), an image signal processor (ISP), a sensor hub processor, or a communication processor (CP)) that is operable independently from, or in conjunction with, the main processor 1121. Additionally or alternatively, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input device 1150 may receive a command or data to be used by other component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 1160 may visually provide information to the outside (e.g., a user) of the electronic device 1101. The display device 1160 may include, for example, a display, a hologram device, or a projector and control circuit to control a corresponding one of the display, hologram device, and projector. According to an embodiment, the display device 1160 may include touch circuit adapted to detect a touch, or sensor circuit (e.g., a pressure sensor) adapted to measure the intensity of force incurred by the touch.

The audio module 1170 may convert a sound into an electrical signal and vice versa. According to an embodiment, the audio module 1170 may obtain the sound via the input device 1150, or output the sound via the sound output device 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, a HDMI connector, a USB connector, a SD card connector, or an audio connector (e.g., a headphone connector),

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to one embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™ wireless-fidelity (Wi-Fi) direct, or infrared data association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. According to an embodiment, the antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuit”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A server, comprising:
at least one processor;
a communication circuit configured to be electrically connected with the at least one processor and transmit or receive a signal with an external device; and
a memory, electrically connected with the at least one processor, for storing group information indicating at least one group including a group including a first electronic device and a second electronic device and control information associated with the at least one group,
wherein the at least one processor is configured to:
obtain information associated with a demand response (DR); and
transmit the control information associated with the group to the first electronic device and the second electronic device, in response to the information associated with the DR.

2. The server of claim 1,
wherein the at least one group includes another group including a third electronic device, and
wherein the at least one processor is configured to transmit control information associated with the another group to the third electronic device, in response to the information associated with the DR.

3. The server of claim 1,
wherein the at least one group includes another group including the first electronic device, and
wherein the at least one processor is configured to transmit control information associated with the another group to the first electronic device, in response to the information associated with the DR.

4. The server of claim 1, wherein the at least one processor is configured to:
obtain information associated an operation from the first electronic device and the second electronic device; and
group the first electronic device and the second electronic device into the group based on the information associated with the operation.

5. The server of claim 1, wherein the at least one processor is configured to:
obtain information associated an operation from the first electronic device and the second electronic device; and
generate the control information associated with the group based on the information associated with the operation.

6. The server of claim 4, wherein the at least one processor is configured to:
obtain an operation pattern of the first electronic device and the second electronic device based on the information associated with the operation; and
group the first electronic device and the second electronic device based on the operation pattern.

7. The server of claim 1, wherein the at least one processor is configured to obtain information associated with an operation performed while applying the DR from the first electronic device.

8. The server of claim 7, wherein the at least one processor is configured to change the group information.

9. The server of claim 7, wherein the at least one processor is configured to change the control information associated with the group, based on the information associated with the operation.

10. The server of claim 8, wherein the at least one processor is configured to change the group information, in response to ending the DR.

11. The server of claim 1, wherein the information associated with the DR is transmitted from a DR server.

12. The server of claim 11, wherein the at least one processor is configured to transmit a DR result according to the information associated with the DR to the DR server.

13. The server of claim 5, wherein the information associated with the operation is log information.

14. The server of claim 1, wherein the control information includes program information associated with the DR.
